(19) United States
(12) Patent Application Publication
(10) Pub. No.: US 2011/0271468 A1
(43) Pub. Date: Nov. 10, 2011

(54) Power toilet bowl cleaning attachment

(76) Inventor: Charles Neil Carr, Florence, AZ (US)

(21) Appl. No.: 12/800,118

(22) Filed: May 10, 2010

(51) Int. Cl. B08B 1/00

(52) U.S. Cl. 15/97.1

(57) ABSTRACT

An implement for cleaning mineral ring build up in a toilet bowl. The inventive device is an attachment driven by a cordless drill. It consists of a ball covered with a non abrasive material attached to a shaft which rotates the ball to remove mineral ring build up on toilet bowls.

### DESCRIPTION OF INVENTION

This application claims priority to Provisional Application #61/2732567, Date Aug. 6, 2009

Item to be patented referred hereafter as Power Toilet Cleaning Attachment, shall be made from the materials and assembled in the manner specified in technical drawing FIG. 1 and FIG. 2, can be easily manufactured and assembled with readily available materials. Power Toilet Bowl Cleaning Attachment is easily attached to the consumer's cordless drill. The rotary action produced by the drill enables the ball end to remove the built-up mineral deposits associated with hard water around the waterline of the toilet bowl.

### DESCRIPTION OF DRAWINGS

FIG. 1 Complete drawing:

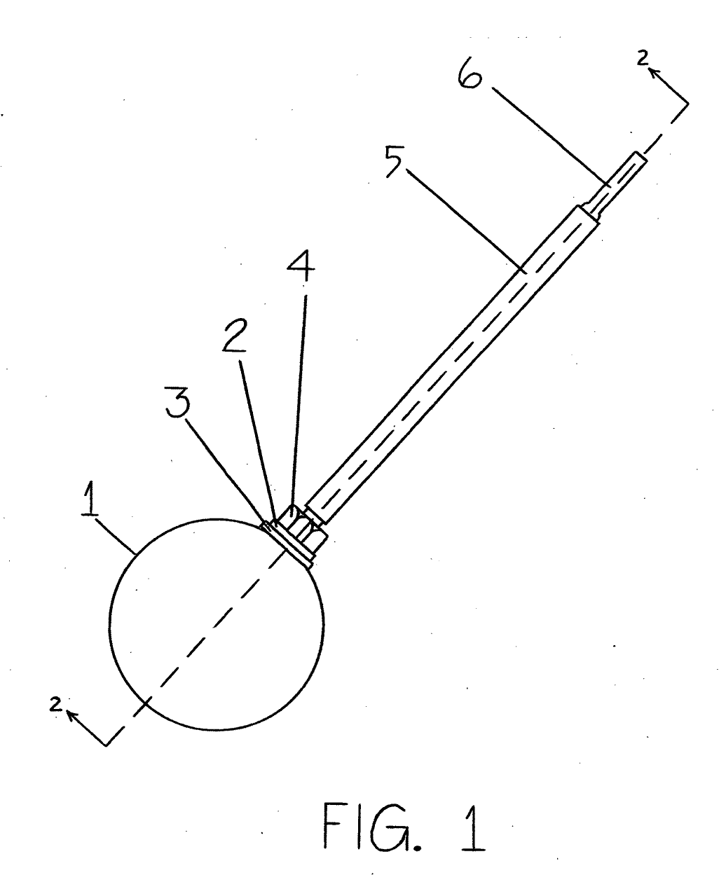

1. A ball with pumice mixture adhered to ball.

2. Expanded fastener in ball.

3. Washer.

4. Nut to lock shaft solid to ball.

5. Plastic sleeve slipped over aluminum shaft for protection purposes.

6. Threaded aluminum shaft to drive ball.

FIG. 2 Sectional drawing:

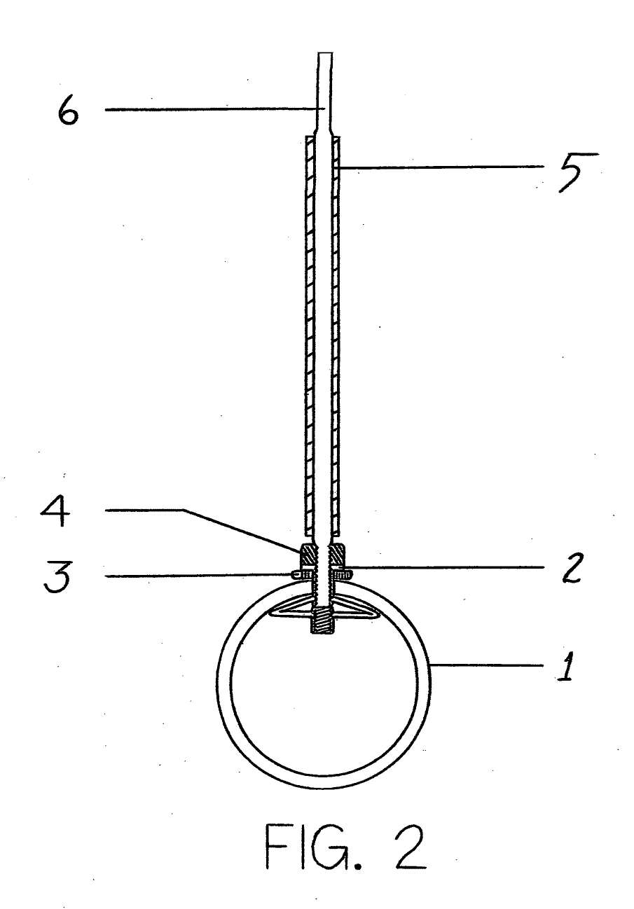

1. A ball with pumice mixture adhered to ball.

2. Expanded fastener in ball.

3. Washer.

4. Nut to lock shaft solid to ball.

5. Plastic sleeve slipped over aluminum shaft for protection purposes.

6. Threaded aluminum shaft to drive ball.

What is claimed is:

1-12. (canceled)

1. A power toilet bowl mineral ring cleaning ball covered with a pumice cleaning agent adhered with waterproof adhesive, shaped to fit within and engage a curved interior surface of a toilet. Ball is attached to a shaft to be driven by a cordless electric drill.
